(19) United States
(12) Patent Application Publication
(10) Pub. No.: US 2010/0080201 A1
(43) Pub. Date: Apr. 1, 2010

(54) Wi-Fi broadcast of links

(75) Inventors: Michael Rosenblatt, Campbell, CA (US); Gloria Lin, San Ramon, CA (US)

Correspondence Address: APPLE INC.;c/o Fletcher Yoder, PC, P.O. Box 692289, Houston, TX, 77269-2289, US

(73) Assignee: Apple Inc., Cupertino, CA (US)

(21) Appl. No.: 12/286,378

(22) Filed: Sep. 30, 2008

(51) Int. Cl. H04W 4/00

(52) U.S. Cl. 370/338

(57) ABSTRACT

A method and system is disclosed for transmitting wide fidelity (Wi-Fi) signals to an electronic device. These Wi-Fi signals may contain content specific links that may be relevant to the surroundings of a user. The user may be able to select these links by interfacing with the electronic device to view media content relevant to the user. The Wi-Fi signals may be transmitted from a base station. The base station can be configured by an operator of the base station to transmit any type of link deemed relevant to a user of the electronic device. Additionally, the base station may be configured to transmit location information to the electronic device for use with a positioning program in the device.

The present disclosure relates generally to broadcasting web links.

### DESCRIPTION OF THE RELATED ART

This section is intended to introduce the reader to various aspects of art that may be related to various aspects that are described and/or claimed below. This discussion is believed to be helpful in providing the reader with background information to facilitate a better understanding of these various aspects. Accordingly, it should be understood that these statements are to be read in this light, and not as admissions of prior art.

Modern electronic devices continue to evolve for use as communication devices connectable to wireless networks. These electronic devices are becoming increasingly compact and portable. Yet despite the reduction in size, the devices are able to offer functionality previously only available in larger non-portable devices. This functionality may include the ability to place and receive telephone calls, transmit and receive text messages, connect with the Internet, send emails, download and play media files, etc., all in one device.

With the vast amount of information and functions available to a user of these electronic devices, it can be difficult to attract the attention of a user of the electronic device to a specific business or points of interest. Accordingly, there exists a need for mechanisms capable of easily alerting users of electronic devices of specific points of interest and other opportunities available to the user.

### SUMMARY

Certain aspects of embodiments disclosed herein by way of example are summarized below. It should be understood that these aspects are presented merely to provide the reader with a brief summary of certain embodiments and that these aspects are not intended to limit the scope of the claims. Indeed, the disclosure and claims may encompass a variety of aspects that may not be set forth below.

An electronic device that includes the capability to access a wireless network is described below. The electronic device may be able to receive wide fidelity (Wi-Fi) transmissions from a base station. These transmissions may include information such as a link to a website or a map. Upon receipt of these Wi-Fi transmissions, the electronic device may alert a user of the existence of the link. The user may subsequently activate the device to access the link provided by the base station. A description of a base station used to provide the Wi-Fi transmissions is also described below. The mechanism by which the base station may be programmed to transmit a specific link is described as well.

Additionally, or alternatively, the base station may be programmed to transmit information to the electronic device detailing the location of the base station. This information could be used in conjunction with a positioning system used by the device to provide a detailed location and/or map to a user. A description of the positioning capabilities of the base station and of the electronic device is also discussed below.

### BRIEF DESCRIPTION OF THE DRAWINGS

Certain embodiments may be understood reading the following detailed description and upon reference to the drawings in which like characters represent like parts throughout the drawings, wherein:

FIG. 1 is a front view of an electronic device, such as a portable media player, in accordance with one embodiment;

FIG. 2 is a block diagram of certain components of the electronic device of FIG. 1;

FIG. 3 is a diagram of a wireless network in which the electronic device of FIG. 1 may operate;

FIG. 4A is a screenshot of the device of FIG. 1 illustrating a map program;

FIG. 4B is a screenshot of the device of FIG. 1 illustrating a map program used in conjunction with a global positioning system (GPS) program;

FIG. 4C is a screenshot of the device of FIG. 1 illustrating a map program used in conjunction with a global positioning system (GPS) program aided by base station location information;

FIG. 5 is an axonometric projection of a base station for use with the electronic device of FIG. 1;

FIG. 6A is a screenshot of the device of FIG. 1 illustrating available Wi-Fi connections;

FIG. 6B is a screenshot of the device of FIG. 1 illustrating received location pointers in conjunction with a Wi-Fi connection of FIG. 6A;

FIG. 7 is a screenshot of the device of FIG. 1 illustrating a bookmark of received location pointers;

FIG. 8 is a screenshot of a setup menu of the base station of FIG. 5;

FIG. 9 is a block diagram representing location pointers that may be broadcast at a concert;

FIG. 10 is a block diagram representing location pointers that may be broadcast at a musical, play, symphony, or opera;

FIG. 11 is a block diagram representing location pointers that may be broadcast at a sporting event;

FIG. 12 is a block diagram representing location pointers that may be broadcast at a school event;

FIG. 13 is a block diagram representing location pointers that may be broadcast at a movie;

FIG. 14 is a block diagram representing location pointers that may be broadcast at a cruise or tour;

FIG. 15 is a block diagram representing location pointers that may be broadcast at a conference;

FIG. 16 is a block diagram representing location pointers that may be broadcast at a wedding;

FIG. 17 is a block diagram representing location pointers that may be broadcast at a museum;

FIG. 18 is a block diagram representing location pointers that may be broadcast at a theme park.

### DETAILED DESCRIPTION OF SPECIFIC EMBODIMENTS

One or more specific embodiments will be described below. In an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed to transmitting wide fidelity (Wi-Fi) signals to an electronic device. These Wi-Fi signals may contain content specific links that may be relevant to the surroundings of a user. The user may be able to select these links by interfacing with the electronic device to view media content relevant to the user. The Wi-Fi signals may be transmitted from a base station. The base station can be configured by an operator of the base station to transmit any type of link deemed relevant to a user of the electronic device. Additionally, or alternatively, the base station may be configured to transmit location information to the electronic device for use with a positioning program in the device.

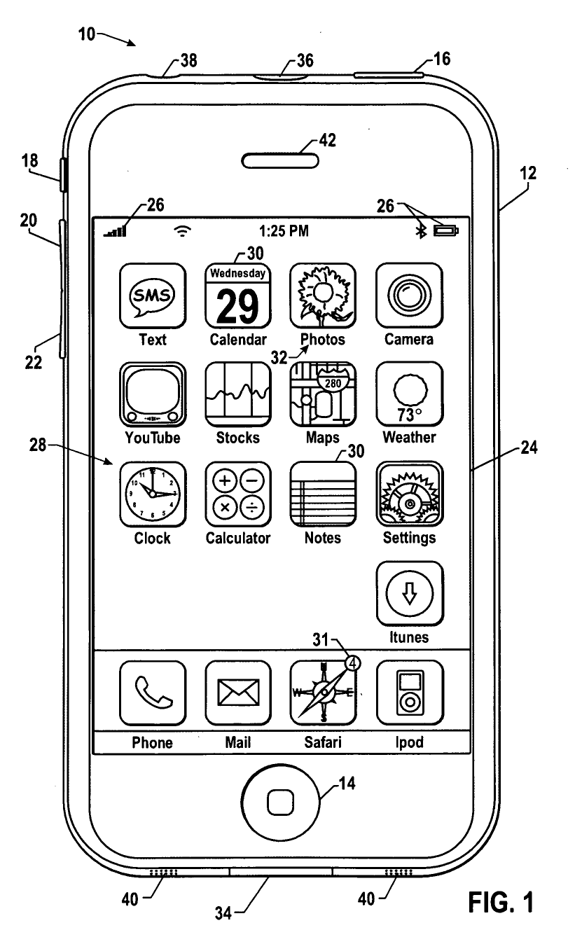

Turning now to the figures, FIG. 1 illustrates an electronic device 10 that may be a handheld device incorporating the functionality of one or more portable devices, such as a media player, a cellular phone, a personal data organizer, and so forth. Depending, of course, on the functionalities provided by the electronic device 10, a user may listen to music, play games, record video, take pictures, and place telephone calls, while moving freely with the device 10. In addition, the electronic device 10 may allow a user to connect to and communicate through the Internet or through other networks, such as local or wide area networks. For example, the electronic device 10 may allow a user to communicate using e-mail, text messaging, instant messaging, or other forms of electronic communication. The electronic device 10 also may communicate with other devices using short-range connections, such as Bluetooth and near field communication. By way of example, the electronic device 10 may be a model of an iPhone® available from Apple Inc. of Cupertino, Calif.

In the depicted embodiment, the device 10 includes an enclosure 12 that protects the interior components from physical damage and shields them from electromagnetic interference. The enclosure 12 may be formed from any suitable material such as plastic, metal, or a composite material and may allow certain frequencies of electromagnetic radiation to pass through to wireless communication circuitry within the device 10 to facilitate wireless communication.

The enclosure 12 allows access to user input structures 14, 16, 18, 20, and 22 through which a user may interface with the device. Each user input structure 14, 16, 18, 20, and 22 may be configured to control a device function when actuated. For example, the input structure 14 may include a button that when pressed causes a “home” screen or menu to be displayed on the device. The input structure 16 may include a button for toggling the device 10 between a sleep mode and a wake mode. The input structure 18 may include a two-position slider that silences a ringer for the cell phone application. The input structures 20 and 22 may include buttons for increasing and decreasing the volume output of the device 10. In general, the electronic device 10 may include any number of user input structures existing in various forms including buttons, switches, control pads, keys, knobs, scroll wheels, or other suitable forms.

The device 10 also includes a display 24 which may display various images generated by the device. For example, the display 24 may show photos, movies, album art, and/or data, such as text documents, spreadsheets, text messages, and email, among other things. The display 24 also may display system indicators 26 that provide feedback to a user, such as power status, signal strength, call status, external device connection, and the like. The display 24 may be any type of display such as a liquid crystal display (LCD), a light emitting diode (LED) display, an organic light emitting diode (OLED) display, or other suitable display. Additionally, the display 24 may include a touch-sensitive element, such as a touch screen.

The display 24 may be used to display a graphic user interface (GUI) 28 that allows a user to interact with the device. The GUI 28 may include various layers, windows, screens, templates, elements, or other components that may be displayed in all, or a portion, of the display 24. Generally, the GUI 28 may include graphical elements that represent applications and functions of the device 10. The graphical elements may include icons and other images representing buttons, sliders, menu bars, and the like. In certain embodiments, the user input structure 14 may be used to display a home screen of the GUI 28. For example, in response to actuation of the input structure 14, the device may display graphical elements, shown here as icons 30, of the GUI 28. The icons 30 may correspond to various applications of the device 10 that may open upon selection of an icon 30. The icons 30 may be selected via a touch screen included in the display 24, or may be selected by user input structures, such as a wheel or button.

The icons 30 may represent various layers, windows, screens, templates, elements, or other components that may be displayed in some or all of the areas of the display 24 upon selection by the user. Furthermore, selection of an icon 30 may lead to a hierarchical navigation process, such that selection of an icon 30 leads to a screen that includes one or more additional icons or other GUI elements. Textual indicators 32 may be displayed on or near the icons 30 to facilitate user interpretation of each icon 30. It should be appreciated that the GUI 28 may include various components arranged in hierarchical and/or non-hierarchical structures.

When an icon 30 is selected, the device 10 may be configured to open an application associated with that icon and display a corresponding screen. For example, when the Weather icon 30 is selected, the device 10 may be configured to open a weather application with a user interface that may provide the current weather conditions to a user. Indeed, for each icon 30, a corresponding application that may include various GUI elements may be opened and displayed on the display 24.

Certain information may be communicated to the user via secondary icons 31. Secondary icons 31 may appear in conjunction with icons 30 to present a user with the opportunity to view items of potential interest. For example, a secondary icon 31 may appear over an Internet (Safari) icon 30 when a user is in range of a network access point broadcasting content. This content could be, for example, Internet links to a campus map on which the user is travelling, a sale at a store near to the user, or information about a point of interest near the user.

The electronic device 10 also may include various input and output (I/O) ports 34, 36, and 38 that allow connection of the device 10 to external devices. For example, the I/O port 34 may be a connection port for transmitting and receiving data files, such as media files. Furthermore, the I/O port 34 may be a proprietary port from Apple Inc. The I/O port 36 may be a connection slot for receiving a subscriber identify module (SIM) card. The I/O port 38 may be a headphone jack for connecting audio headphones. In other embodiments, the device 10 may include any number of I/O ports configured to connect to a variety of external devices, including but not limited to a power source, a printer, and a computer. In other embodiments, multiple ports may be included on a device. Additionally, the ports may be any interface type, such as a universal serial bus (USB) port, serial connection port, Firewire port, IEEE-1394 port, or AC/DC power connection port.

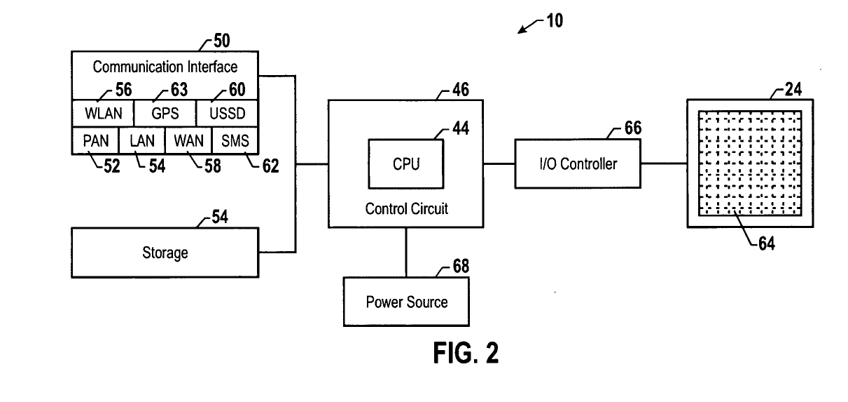

The electronic device 10 may also include various audio input and output structures 40 and 42. For example, the audio input structures 40 may include one or more microphones for receiving voice data from a user. The audio output structures 42 may include one or more speakers for outputting audio data, such as data received by the device 10 over a cellular network. Together, the audio input and output structures 40 and 42 may operate to provide telephone functionality. Further, in some embodiments, the audio input structures 40 may include one or more integrated speakers serving as audio output structures for audio data stored on the device 10. For example, the integrated speakers may be used to play music stored in the device 10. Additional details of the illustrative device 10 may be better understood through reference to FIG. 2, which is a block diagram illustrating various components and features of the device 10 in accordance with one embodiment of the present invention.

Additional details of the illustrative device 10 may be better understood through reference to FIG. 2, which is a block diagram illustrating various components and features of the device 10 in accordance with one embodiment of the present invention. The block diagram may include the display 24 as discussed above, as well as many other components.

The operation of the device 10 may be controlled by a central processing unit (CPU) 44 and a control circuit 46 that provide the processing capability required to execute the operating system, programs, the GUI 28, and any other functions of the device 10. The CPU 44 may include a single processor or it may include a plurality of processors. For example, the CPU 44 may include “general purpose” microprocessors, a combination of general and special purpose microprocessors, instruction set processors, graphics processors, video processors, and/or related chips sets, and/or special purpose microprocessors. The control circuit 46 may include one or more data buses for transferring data and instructions between components of the device 10. The control circuit 46 also may include on board memory for caching purposes.

Information used by the CPU 44 may be located within long-term storage 48. The long-term storage 48 of electronic device 10 may be used for storing data required for the operation of the CPU 44 as well as other data required by the device 10. For example, the storage 48 may store the firmware for the electronic device 10 that is used by the CPU 44. The firmware may include an operating system, as well as other programs that enable various functions of the electronic device 10, GUI functions, and/or processor functions. The storage 48 also may store components for the GUI 28, such as graphical elements, screens, and templates. Additionally, the long term storage 48 may store data files such as media (e.g., music and video files), image data, software, preference information (e.g., media playback preferences), wireless connection information (e.g., information that may enable the device 10 to establish a wireless connection, such as a telephone connection), subscription information (e.g., information that maintains a record of podcasts, television shows or other media to which a user subscribes), telephone information (e.g., telephone numbers), and any other suitable data. The long term storage 48 may be non-volatile memory such as read only memory, flash memory, a hard drive, or any other suitable optical, magnetic, or solid-state computer readable media, as well as a combination thereof.

One or more communication interfaces 50 may also be present in the device 10, and may provide additional connectivity channels for receiving and transmitting information. The communication interface 50 may represent, for example, one or more network interface cards (NIC) or a network controller as well as associated communication protocols. The communication interface 50 may include several types of interfaces, including but not limited to a personal area network (PAN) interface 52, a local area network (LAN) interface 54, a wireless local area network (WLAN) interface 56, a wide area network (WAN) interface 58, an unstructured supplementary service data (USSD) interface 60, a short message service (SMS) interface 62, and a global positioning system (GPS) interface 63.

The PAN interface 52 may provide capabilities to network with, for example, a Bluetooth® network, an IEEE 802.15.4 (e.g., ZigBee) network, or an ultra wideband network (UWB). As should be appreciated, the networks accessed by the PAN interface 52 may, but do not necessarily, represent low power, low bandwidth, or close range wireless connections. The PAN interface 52 may permit one electronic device 10 to connect to another local electronic device, such as a computer or portable media player, via an ad-hoc or peer-to-peer connection. However, the connection may be disrupted if the separation between the two electronic devices exceeds the range of the PAN interface 52.

The LAN interface 54 and WLAN interface 56 may provide longer-range communication channels, generally exceeding the range available via the PAN interface 52. The LAN interface 54 may represent an interface to a wired Ethernet-based network, and the WLAN interface 56 may represent an interface to a wireless LAN, such as an IEEE 802.11x wireless network, i.e. a Wi-Fi network. Additionally, in many cases, a connection between two electronic devices via the LAN interface 54 may involve communication through a network router or other intermediary device.

Connection to a wide area network (WAN) may be provided through the WAN interface 58. In certain embodiments, the wide area network may include a private network maintained by a merchant for transferring information between retail stores. The WAN interface 58 may permit a connection to a cellular data network, such as the Enhanced Data rates for GSM Evolution (EDGE) network or the 3G network. When connected via the WAN interface 58, the electronic device 10 may remain connected to the Internet and, in some embodiments, to another electronic device, despite changes in location that might otherwise disrupt connectivity via the PAN interface 52 or the LAN interface 54.

In certain embodiments, the device 10 may use a device identification networking protocol to establish a connection with an external device through a network interface. For example, both the device 10 and the external device may broadcast identification information using Internet protocol (IP). The devices may then use the identification information to establish a network connection, such as a PAN connection or a LAN connection, between the devices. By way of example, the device identification protocol may be Bonjour® by Apple Inc.

Small size communications may be sent using the USSD interface 60 and the SMS interface 62. The USSD interface 60 may facilitate the transmission of real-time text messages over GSM signaling channels. For example, the USSD interface 60 may be used to query inventory or price information for an article of merchandise. The SMS interface 62 may allow transmission of text messages of 140 bytes or less. In certain embodiments, larger size messages may be sent using concatenated SMS. Additionally, the GPS interface 63 may receive positioning data that may be used in conjunction with a GPS program to show the location of the electronic device 10 on a map.

Preferences that may determine properties of a communication interface 50 may be stored within the storage 54 and may be set by the device manufacturer or by a user through the GUI 28 (FIG. 1). The preferences may, for example, include a list of networks that the device 10 may connect to. The preferences also may govern the selection priority between the various interfaces 52-63. For example, the device 10 may be configured to communicate through the LAN interface 54 whenever a LAN connection is available. Alternatively, the preferences may be based on properties of the data to be transferred. For example, a user may specify that data transfers involving a large volume of data be communicated only through the WLAN interface 56 or the WAN interface 58.

Information received through the communication interface 50, as well as information contained in the storage 48, may be displayed on the display 24. As noted above, a user may select information to display through the GUI 28 (FIG. 1). A touch screen 64 may be positioned in front of or behind the display 24 and may be used to select graphical elements, such as the icons 30 (FIG. 1), shown on the display 24. The touch screen 64 may be configured to receive input from a user's or object's touch and to send the information to the CPU 44, which interprets the touch event and performs a corresponding action. The touch screen 64 may employ any suitable type of touch screen technology such as resistive, capacitive, infrared, surface acoustic wave, electromagnetic, or near field imaging. Furthermore, the touch screen 64 may employ single point or multipoint sensing.

An input/output (I/O) controller 66 may provide the infrastructure for exchanging data between the control circuit 46 and input/output devices, such as the touch screen 64 and the display 24. The I/O controller 66 may contain one or more integrated circuits and may be integrated within the control circuit 46 or exist as a separate component. The I/O controller 66 also may provide the infrastructure for communicating with external devices through the I/O ports 34, 36, and 38 shown in FIG. 1 and may be used for connecting the device 10 to an external computer, bar code scanner, a printer, audio headphones, or the like.

The I/O controller 66 also may provide the infrastructure for communicating with the CPU 44 through the input structures 14, 16, 18, 20, and 22 shown in FIG. 1. The user input structures 14, 16, 18, 20, and 22 may be used in conjunction with, or independently of, the touch screen 64 to select inputs for the device 10.

The portability of the device 10 makes it particularly well suited for travel with a user. To facilitate transport and ease of motion, the device 10 may include an integrated power source 68 for powering the device 10. The power source 68 may include one or more batteries, such as a Li-Ion battery, which may be user-removable or secured to the enclosure 12. The power source 68 may also be rechargeable. In certain embodiments, the proprietary connection I/O port 34 may be used to connect the device 10 to a power source for recharging the power source 68. In this manner, the power source 46 may be able to receive power from an external AC or a DC power source, such as an electrical outlet or a car cigarette lighting mechanism.

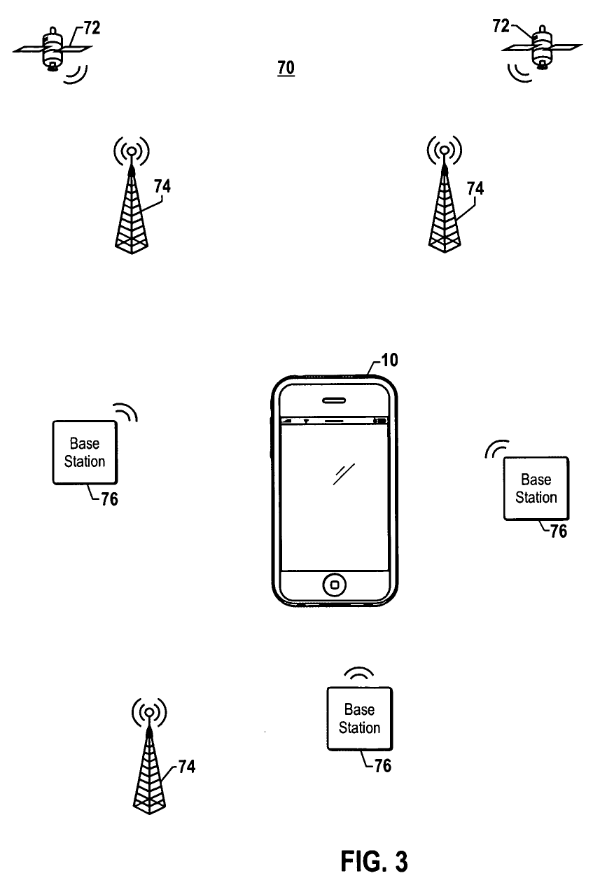

The portability of electronic device 10 also provides the ability of the device 10 to connect to multiple communication sources. Examples of these communication sources are illustrated in FIG. 3, which shows the electronic device 10 as part of a wireless network 70. The wireless network 70 may include satellites 72, communication towers 74, and/or base stations 76. Satellites 72 may be used in conjunction with the device 10 tracking of the device via a global positioning system (GPS). GPS may make use of signals transmitted between the device 10 and a plurality of earth orbiting satellites to determine the location of the electronic device 10. The electronic device 10 may estimate the distance to the satellites 72 based on the time it takes for signals to reach it, and may use that information to identify its location. However, the uses of GPS typically require that the electronic device 10 have a clear line of sight to the satellites 72 for determination of the location of the device.

To aid in the determination of the location of the electronic device 10, the electronic device 10 may receive signals from communication towers 74, such as cellular towers. These communication towers 74 may provide location information to the electronic device 10, even when a line of sight is unavailable. In addition, the communication towers 74 may provide wireless telecommunications to the electronic device 10, as well as connection to a cellular data network, such as the Enhanced Data rates for GSM Evolution (EDGE) network or the 3G network. Communication to these networks may be made via the communication interface 50 of the electronic device 10.

However, while location information may be transmitted via the communication towers 74 without a line of sight, pinpoint location of the electronic device 10 may still be difficult to achieve. To aid the communication towers 74 in situations such as these, the wireless network 70 may include base stations 76. These base stations 76 may provide a wireless local area network (WLAN) or Wi-Fi connection across which the WLAN interface 56 may communicate. In one embodiment, the base stations 76 may broadcast wirelessly using one or more of the IEEE 802.11 wireless network standards. By programming each base station 76 with location coordinates corresponding to that base station 76, and by transmitting these coordinates to the electronic device 10, the user may be able to better estimate the location of the device 10 with a higher degree of accuracy, even when line of sight to satellites 72 and communication towers 74 is unavailable. For example, a user in a building may be able to track the movement of their device 10 throughout the building if one or more base stations 76 are positioned throughout the building. This may be accomplished based on the electronic device 10 receiving location coordinates and determining its distance from the one or more broadcasting base stations 76 based on the strength of the received signal transmitting those location coordinates.

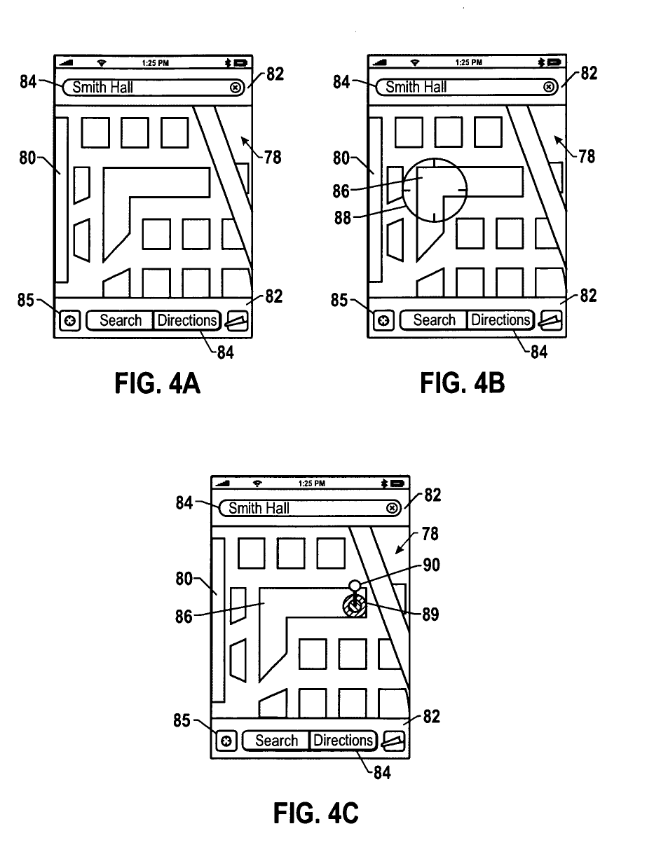

FIGS. 4A-C illustrate this process via screenshots of the device 10. FIG. 4A illustrates the device 10 showing a screen 78 displaying a map 80, which may be accessed through an application such as an Internet or preprogrammed map application, provided by, for example Yahoo!® or Google™. Alternatively, the map 80 could be a custom may provided by a web link sent by a base station 76. In the illustrated embodiment, border areas 82 located at the top and bottom of the screen 78 include selectable input features 84. The input features 84 may include a GPS icon 85 selectable to enable a GPS program which may be used to show the physical location of the device 10 on the map 80. The input features 84 also may include an input area, such as a browser bar shown at the top of the screen that allows a user to enter information such as a location to display on the screen 78. For example, a user may enter a location of interest in the browser bar to receive a map including that location.

FIG. 4B illustrates a screenshot of device 10 after a user has selected the GPS icon 85 to enable a GPS program to show the physical location of the device 10 on the map 80. The user may, for example, be in a building 86. While in the building 86, the user may not have a line of sight with the satellites 72 and the building could obscure contact with the communication towers 74 as well. As such, a relatively large GPS sight 88 may be displayed on the screen 78. This GPS sight 88 may show that the electronic device 10 is located approximately in the building 86. However, the GPS sight 88 may not be able to accurately pinpoint the location of the device 10 inside of the building 86.

This situation can be addresses by use of the base stations 76. FIG. 4C illustrates a second screenshot of device 10 after a user has selected the GPS icon 85 to enable a GPS program to show the physical location of the device 10 on the map 80. Again, the user may, for example, be in the building 86 without a line of sight with the satellites 72 and experience obscured contact with the communication towers 74. However, in FIG. 4C, one or more base stations 76 may be positioned in or near the building 86. Because these base stations 76 may transmit location coordinates of the one or more base stations 76 to the electronic device 10, the location of the device 10 may be found by receiving the location coordinates and determining the distance of the device 10 from the one or more broadcasting base stations 76 based on the strength of the received location coordinate transmissions from the one or more base stations 76, for example. This is illustrated in FIG. 4C as a smaller GPS sight 89, as well as with a pin location 90 of the device 10 inside the building 86. Thus, as a user moves throughout the building 86, the pin location 90 may move correspondingly on the map 80. This may be useful, for example, for a lost user trying to exit the building 86, or a particular side to access a particular street. By viewing the movement of a pin location 90, the lost user may be able to navigate through the building 86 and exit on the desired side. Additionally, a customized map of the building 86, for example, including floor maps selectable by the user, could be available on a URL broadcast by a base station 76 to aid in navigation through the building 86.

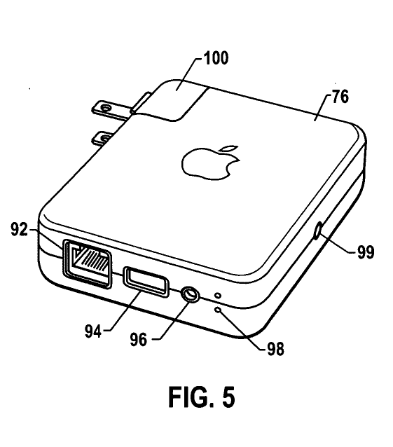

FIG. 5 illustrates an example of the base station 76. By way of example, the base station 76 may be a model of an AirPort Express® available from Apple Inc. of Cupertino, Calif. The base station 76 may include an Ethernet port 92, a USB port 94, a line out port 96, a reset button 98, and an AC plug adapter 100. The Ethernet port 92 may be a 10/100 Ethernet port 92 that may act as a connection interface between the base station 76 and an Ethernet device such as a computer, a cable modem, a DSL modem, an existing Ethernet network, etc. The base station 76 may also include a USB port 94. The USB port 94 may be used as a print server interface. That is, the USB port 94 may be used to connect the base station 76 to, for example, a printer compatible with the base station 76.

The base station 76 may also include a line out port 96. The line out port 96 may be an analog and optical digital audio stereo mini-jack. This line out port 96 may allow for the connection of a home stereo or of powered speakers to the base station 76. In this manner, the base station 76 may be used to stream music to a sound system of a user. The base station 76 may further include a reset button 98. The reset button 98 may be used to troubleshoot and/or return the base station 76 to its factory settings. The base station 76 may additionally include a status light 99 that may be used to inform a user of the health of the base station 76.

The base station 76 may be powered by an AC plug adapter 100. The AC plug adapter 100 may be used to plug the base station 76 into an outlet. Additionally, the AC plug adapter 100 may be built directly into the base station 76, alleviating power cables and/or a power brick for powering of the base station 76. Additionally, the AC plug adapter 100 may retract into the housing of the base station 76 for ease of transport.

As described above, with respect to FIG. 1, certain information may be communicated to the user via secondary icons 31 that may appear in conjunction with icons 30 to present a user with the opportunity to view items of potential interest. For example, a secondary icon 31 may appear as a bubble over the Internet (Safari) icon 30 when a user is in range of a base station 76 broadcasting content. Alternatively, the device 10 may ring in a certain manner, or with a specified ringtone, to alert the user that a location link (a link of potential interest) is being broadcast via a base station 76. Furthermore, the device 10 may be configured to vibrate when a location link is received by the device 10.

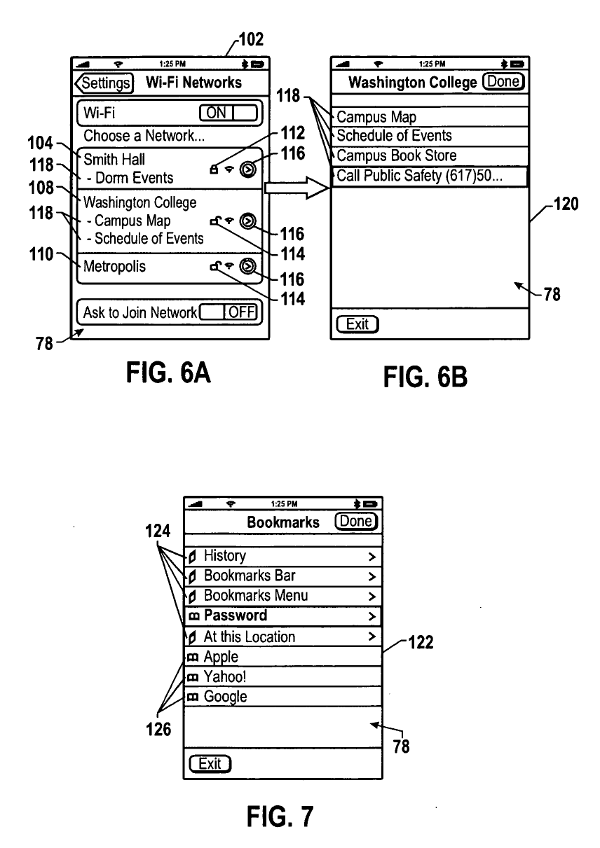

These broadcast location links that may be received by the electronic device 10 may be transmitted as location pointers. Upon receiving the location links, and after the user selects an Internet icon 30 with an accompanying secondary icon 31, a Wi-Fi network preview screen 102 of FIG. 6A may be displayed on the screen 78 of the device 10. The Wi-Fi network preview screen 102 may include all Wi-Fi networks currently being received by the device. For example, the device 10 may receive a Wi-Fi broadcast from a nearby dormitory, from a campus network, and/or from a city network. Accordingly, the electronic device in Wi-Fi network preview screen 102 may display a Smith Hall Wi-Fi broadcast icon 104, a Washington college Wi-Fi broadcast icon 108, and a Metropolis Wi-Fi broadcast icon 110.

Additionally, icons 104, 108, and 110 may indicate that their corresponding networks are locked from public use, via cryptographic techniques, such as Wired Equivalent Privacy (WEP) encryption or Wi-Fi Protected Access (WPA) encryption. A locked icon 112 may indicate that the Wi-Fi broadcast is encrypted and that access may be provided through use of a password. In contrast, an unlocked icon 114 may indicate that a Wi-Fi broadcast associated with the given unlocked icon 114 is free of encryption, i.e. no password is required to access the Wi-Fi network corresponding to the unlocked icon 114.

To access a particular Wi-Fi network, a user may select an access icon 116 corresponding to the desired network. Additionally, to aid in selection of a desired network, location pointers 118 associated with a particular Wi-Fi-network may be displayed on the network preview screen 102. In this manner, the location pointers may influence which Wi-Fi network is chosen. For example, a visitor to a college may be more interested in connecting to the a campus network to view location pointers 118 associated with a campus-related information such as a campus map or a schedule of events, rather than a citywide network, without any relevant location pointers 118.

FIG. 6B illustrates an interface page 120 that may be displayed on the screen 78 of device 10 when the Washington college Wi-Fi broadcast icon 108 is selected by a user. The interface page 120 may contain a full list of location pointers 118. Selection of any of these location pointers 118 may direct the device 10 to navigate to an Internet web address associated with selected the location pointer 118, make a telephone call associated with the location pointer 118, and/or launch a map application associated with the location pointer 118. In this manner, the location pointers 118 may be associated with content relevant to the location of the base station 76, such as links from a university that may include Internet links to a campus map, a link to a schedule of events to occur at a given location, a link to the campus book store announcing a sale on certain items, and/or a link to the phone number for campus security. In another example, links could be provided to Internet web sites, such as iTunes™.

It should be noted that to facilitate access to the content associated with the location pointers 118, the base station 76 may allow the device 10 to utilize a WAN connection connected to the base station 76. For example, if a user selects the campus book store location pointer 118, the base station 76 may allow the device 10 to utilize a WAN connection through the base station 76 to access a web page associated with selected location pointer 118. However, the WAN connection of the base station 76 may not always be available to a device 10. Accordingly, the device 10 may determine if the base station 76 allows for a connection via a base station 76 WAN connection. If the base station 76 allows for a connection via the base station 76 WAN connection, the device 10 may connect to the Internet utilizing the WAN connection of the base station 76. If, however, the WAN connection of the base station 76 is unavailable to the device 10, the device 10 may undertake to make a connection via one or more of its own networks, such as EDGE or a 3G connection. Thus, the electronic device 10 does not need to have access to the network provided by the base station 76 to receive the location pointers.

Additionally, connection to the Internet via the WAN connection of the base station 76 may occur certain conditions are met. For example, if a user agrees to view one or more advertisements transmitted to the device 10, Wi-Fi access via the WAN of the base station 76 may be granted. Furthermore, if the device 10 has Wi-Fi capability, but does not have the capability to connect to a telephone network, such as the iPod Touch® available from Apple Inc. of Cupertino, Calif., the broadcast station 76 may utilize Internet telephone software, such as Voice-over-Internet protocol (VoIP) software, to complete a phone call, when, for example, a phone number is broadcast as a location pointer 118. Thus, if a base station 76 broadcasts a location pointer 118 corresponding to a phone number, and the base station 76 detects a device 10 that does not have the capability to connect to a telephone network, then the base station may utilize VoIP software to complete a telephone call with the device 10.

Alternatively, the base station 76 may merely broadcast location pointers 118 as beacon packets without a WAN connection. These beacon packets may contain a network service set identifier (SSID), i.e. the name used to identify the particular broadcasting base station 76, as well as the location pointers 118. In this manner, a base station 76 that may be completely unconnected from any WAN, either by physical wire or wirelessly, may still be able to transmit location pointers 118 as a disconnected beacon. That is, location pointers 118 may be broadcast via the base station 76 as Wi-Fi links, without a WAN connection available to the device 10. In this embodiment, the device 10 may connect to the Internet via its own connection capabilities, such as via an EDGE or a 3G connection.

A user may also want to bookmark certain location pointers for viewing at a later time. FIG. 7 illustrates a screen shot of device 10 that illustrates a bookmark page 122 that may be displayed on the screen 78. The bookmark page 122 may include a list of folders 124 for bookmarked pointers, as well as a list of pointers to specific web pages 126. One of the items in the list of folders 124, for example, the “At this Location” folder, may be associated with the location pointers 118. Selection of this “At this Location” folder may bring up the screen illustrated in FIG. 6B, so that a user may be able to view the previously received location pointers 118 at a later time.

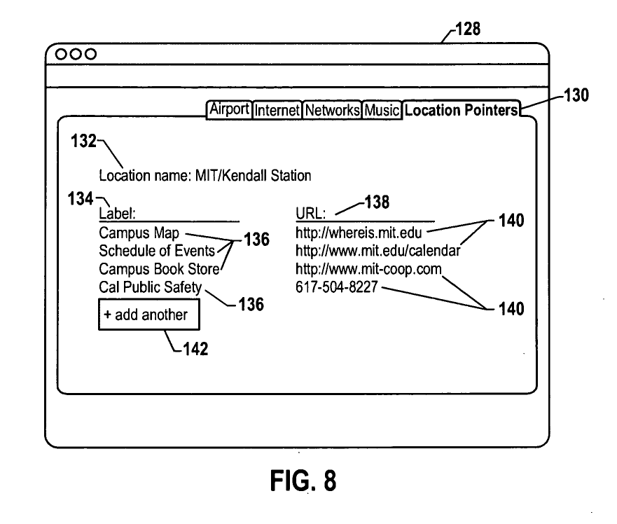

FIG. 8 illustrates a setup page 128 that may be used to program the base station 76 with one or more location pointers 118. The setup page 128 may be a program or a set of software instructions tangibly stored on a machine readable medium, such as memory in the base station 76, which may cause a processor to perform steps of generation and editing of the location pointers 118 as follows.

The setup page 118 may include a specific setup tab 130. Upon selection of the setup tab 130 by a user, the location name 132 of the base station 76 may be displayed on the setup page 128. Furthermore, a label column 134 may be displayed. The label column 134 may list the display names 136 corresponding to the location pointers 118 currently set to be broadcast via the base station 76. Additionally, a URL list 138 that corresponds to addresses for Internet locations may be displayed. The URL list 138 may include destinations 140 corresponding to the location pointers 118. For example, the destinations 140 may include Internet addresses or telephone numbers to be accessed when a user selects a particular location pointer 118. In another embodiment, the setup page 128 may allow for creation of location pointers 118 at a server in a network and transmission of the location pointers to various base stations 76 in a network.

Additionally, by clicking on any display name 136, a user may be able to edit the selected display name 136 to change the name of a location pointer 118 broadcast by the base station 76. Furthermore, by clicking on any destination 140, a user may be able to edit the selected destination 140 corresponding to a given location pointer 118. In this manner, a user may use the setup page 128 to edit both display information and destination information for a location pointer 118 broadcast by the base station 76.

The setup page 128 of FIG. 7 may further include an add tab 142. By clicking the add tab 142, a user may be able to input a new display name 136 to the label column 134, as well as a new destination 140 in the URL list 138. Once a user has added a new display name 136 and a new destination 140, a new location pointer 118 corresponding to the newly entered information may be broadcast by the base station 76. In this manner, a user may be able to add new location pointers 118 to be broadcast by the base station 76.

The act of adding and/or editing the new location pointers 118 to be broadcast by the base station 76 may be accomplished via a set-up program that resides on, for example, a personal computer. The personal computer may connect, either wirelessly or via a wired connection, to the base station 76. Setup page 128 may then appear on the screen of the personal computer for editing of, for example, the location pointers 118, the display names 136, and the destinations 140. Alternatively, a web based configuration transmitted from the base station 76 itself may be received by, for example, a personal computer. For example, a setup page 128 may be transmitted to the personal computer as part of an internal setup program stored on the base station 76, for editing of, for example, the location pointers 118, the display names 136, and the destinations 140. Furthermore, the set-up page 128 may be part of a software program that is stored remotely with the manufacturer of the base station 76. In this embodiment, the setup page 128 may be accessed remotely, via a web server of a manufacturer. Upon completion of a log in process, for example, providing an account name and a password, the setup page 128 would be available for editing.

The base station 76 may also include security protocols such as WEP or WPA encryption. These security protocols may utilize password protection to prevent public access of private information, such as base station setup information, while allowing public access of public information, such as location pointers 118. In this manner, the base stations 76 may protect private information, while public information to be viewed without any encryption.

It is envisioned that the system and method of broadcasting Wi-Fi links may have other functions as described in the copending and commonly assigned U.S. patent application Ser. No. ______, filed Sep. 30, 2008, entitled, “SYSTEM AND METHOD FOR PROVIDING ELECTRONIC EVENT TICKETS,” by Michael Rosenblatt et al., the disclosure of which is hereby incorporated by reference in its entirety for all purposes. For example, location pointers 118 may be directed to users at ticketed events.

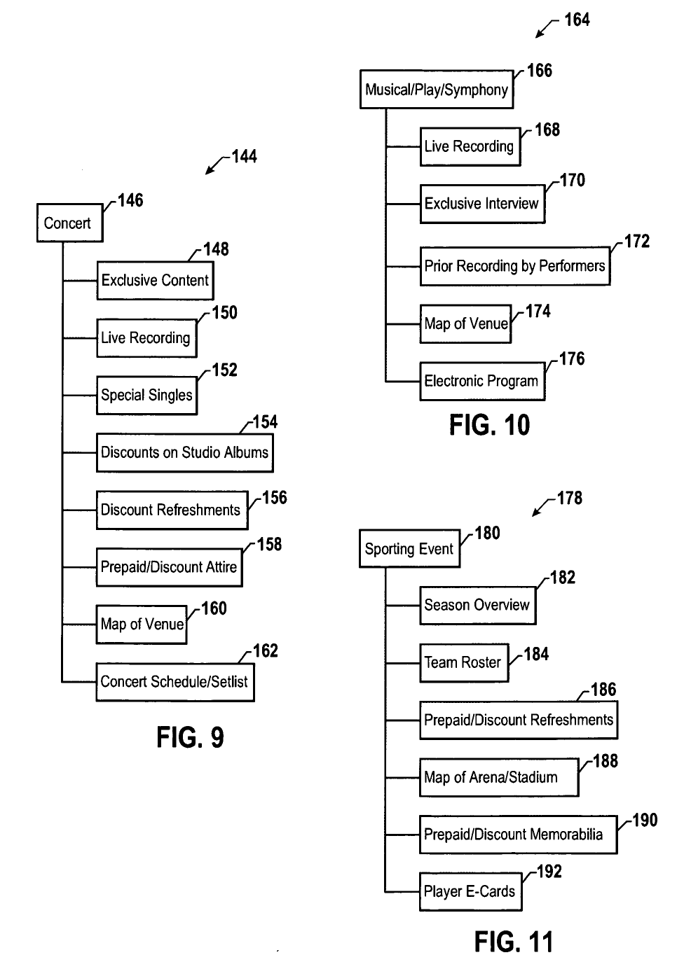

The following example may summarize a benefit diagram 144 of FIG. 9. A user may attend a concert 146. The concert 146 may be at a location that has set up one or more base stations 76 to broadcast location pointers 118. These location pointers 118 may include links for a user to download exclusive content 148, special singles 152, or purchase discounted studio albums 154. Expecting to be thirsty and wanting a concert souvenir, the user may receive a link allowing the user to prepay, or receive a discount code for refreshments 156 and concert attire 158. The user may be able to access a map of the venue 160 via the location pointers 118, and if the user is unsure of what song the band is currently playing, the user may check the device 10 to obtain the lyrics and the name of the currently playing song by way of the setlist 162. Additionally, after listening to a few songs, the user may decide to purchase a live recording 150 of the concert. After the concert has ended, the user may download the live recording 150 via the device 10 or via another electronic device.

Turning next to FIG. 10, a benefit diagram 164 illustrates benefits that may be associated with a musical, play, symphony, or opera 166. It should be understood that the benefits described in the diagram 164 are intended to be exemplary and are not intended to be exclusive. Such benefits may include, for example, location pointers 118 to purchase a live recording 168 of the event or may include exclusive interviews 170 with the artists, actors, playwrights, composers, or producers, etc. associated with the musical, play, symphony, or opera 166, which may be obtained in the manner described above with reference to FIG. 9.

Some location pointers 118 transmitted at a location hosting the musical, play, symphony, or opera may include prior recordings of performances or performers 172, the theater company, the orchestra, the composer, etc. The prior recordings 172 may include certain free or prepaid items, but may also include the option to purchase such prior recordings 172. As such, the recordings of performances 172 may be obtained in the manner described above with reference to FIG. 9.

To assist with finding one's seat, or an exit, while at the musical, play, symphony, or opera event, a base station at the event location may transmit a location pointer 118 corresponding to a map of the venue 174. The location pointers 118 may also transmit a link to an electronic program 176. The electronic program 176 may be received as, for example, a data file. The electronic program 176 may include information typical to a printed program for a musical, play, symphony, or opera. In association with the electronic program 176 or as a separate benefit, the device 10 may display lyrics and translations of songs and/or dialogue of the musical, play, symphony, or opera. Such a benefit may be particularly useful with foreign-language productions.

In another example, FIG. 11 illustrates an associated benefits diagram 178 for a sporting event 180. It should be understood that the benefits described in the diagram 178 are intended to be exemplary and not exclusive. Such benefits may include, for example, receiving a location pointer 118 for a season overview 182, which may represent, for example, links to various sports news reporting regarding both teams associated with the sporting event, as well as press releases released by the teams competing in the sporting event. Similarly, a location pointer 118 may be broadcast corresponding to one or both teams rosters 184. The team rosters 184 may provide a listing of the players which may appear in the sporting event, as well as the known status of the players. The sporting event 180 venue may further broadcast a location pointer 118 that may be directed to prepaid or discount refreshments 186. The prepaid or discount refreshments 186 may be obtained in the manner described above with reference to FIG. 9.

With continued reference to the benefits diagram 178 of FIG. 11, venue of the sporting event 180 may also broadcast a map of the sporting event venue 188. The map of the sporting event venue 188 associated with the sporting event 180 may be received by the device 10 in a variety of forms, such as a web archive file or a hyperlink to an online map, and may be displayed in a web browser, such as Safari®, or a dedicated map application, such as Maps for the Apple iPhone®.

The location pointers 118 broadcast at the venue of the sporting event 180 may further include prepaid or discount memorabilia 190. As should be appreciated, the prepaid or discount memorabilia 190 may be accessible to the user in the same manner as the prepaid or discount refreshments 186. The sporting event 180 may also broadcast a location pointer that provides a user the opportunity to download certain other special benefits such as player e-cards 192. Such player e-cards 192 may function as electronic versions of paper sports player cards. For example, the e-cards 192 may include, for example, the player's name, number and position in text, a digital photo of the player, player statistics, and a short biography about the player.

The following example may illustrate the use of the benefits disclosed in the benefit diagram 178 of FIG. 11. A user at attending a sporting event 180 may be able to, for example, review what to expect with a season overview 182 and a team roster 184 on the device 10. Expecting to be thirsty and wanting a souvenir, the user may prepay for refreshments 186 and team memorabilia 190. The user may assisted with a map of the stadium 188, quickly find the location of his seat, the restrooms, and the nearest concession stand. The user may further download, view, and/or trade the player e-cards 192 at slow points in the game or receive a coupon to purchase a half-priced drink 186 after the fifth inning.

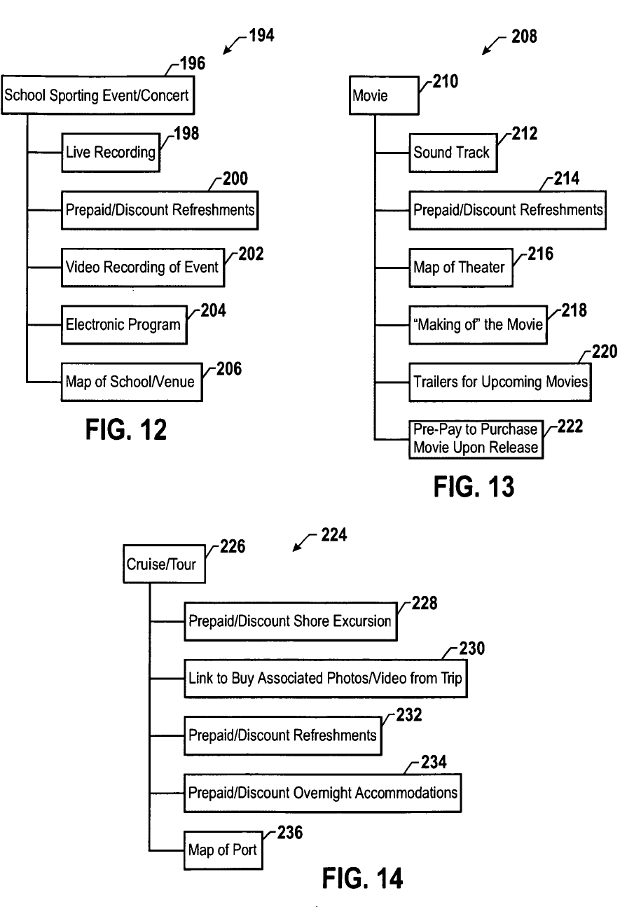

It should be appreciated that the use of base stations 76 to transmit location pointers 118 may extend to non-commercial ventures as well as commercial ventures. One such non-commercial venture may be exemplified in a benefit diagram 194, as displayed in FIG. 12, representing various location pointers that may be associated with a school event 196. It should be appreciated that the school event 196 location pointers may be obtained and used in any electronic device 10 according to the techniques described above. Moreover, it should be understood that the benefits described in the diagram 196 are intended to be exemplary and not exclusive.

The location pointers 118 that may be broadcast at the school event 196 may include, for example, a live recording 198 of the event or prepaid or discount refreshments 200. The live recording 198 and the prepaid or discount refreshments 200 may be obtained using the techniques discussed above. Because many school events 196, such as concerts and sporting events, may be recorded on video, a video recording of the event 202 may also be broadcast as a location pointer 118. For example, a device 100 having the electronic school event ticket 196 may enable a user to purchase or reserve an electronic or hard copy of the video recording 202 of such an event 196. To do so, the device 10 may receive, for example, a location pointer to a website, a phone number, or an email address. Using such data, the user may provide those responsible for recording the event 196 an indication that the user would like a copy of the video recording 202. Thus, the video recording 202 may be made available to a user in largely the same manner as the live recording 198. With continued reference to the benefits diagram 194 of FIG. 12, the school event venue 196 may also broadcast a map of the school event venue 206. The map of the school event venue 206 associated may be received by the device 10 in a variety of forms, such as a web archive file or a hyperlink to an online map, and may be displayed in a web browser, such as Safari®, or a dedicated map application, such as Maps for the Apple iPhone®. Additionally, a location pointer 118 may include a link to an electronic program 204. The electronic program 204 may be similar to the electronic program 176 described with reference to FIG. 9.

Turning to FIG. 13, a benefit diagram 208 describes various location pointers 118 that may be associated with a movie venue 210. The movie venue may provide a user with a location pointer corresponding to an option to purchase the movie soundtrack 212. Additionally, the movie venue 210 make a location pointer 118 available that provides prepaid or discount refreshments 214, as well as a map of the theater 216, to aid a user in the finding the location of the theater in which a particular movie is playing. Furthermore, the movie venue 210 may provide location pointers 118 that link to web sites showing the “Making Of” the movie 218 as well as trailers for upcoming movies 220. Another location pointer 118 that may be provided may present a user with the option to prepay to purchase the movie upon its release 222 to the general public. For example, following the end of the movie, the user may be prompted to pre-purchase the movie from iTunes® or from another on-line digital content distribution service. To encourage users to prepay for the movie 222, a discount may be offered prior to its release.

As should be appreciated, location pointers 118 may be used in a variety of settings. Turning to FIG. 14, a benefit diagram 224 may represent various benefits that may be associated with a cruise or tour 226. For example, location pointers 118 allowing a user to prepay for a shore excursion, or provide a discount for a shore excursion 228 may be provided. Additionally, as noted by the diagram 224, the cruise or tour 226 may also enable a user of an electronic device 10 to obtain photos or videos from the cruise or tour 230, purchase or prepay for discount refreshments 232, purchase or prepay for discount overnight accommodations 234, and/or receive a map of a port that the cruise 236 will enter.

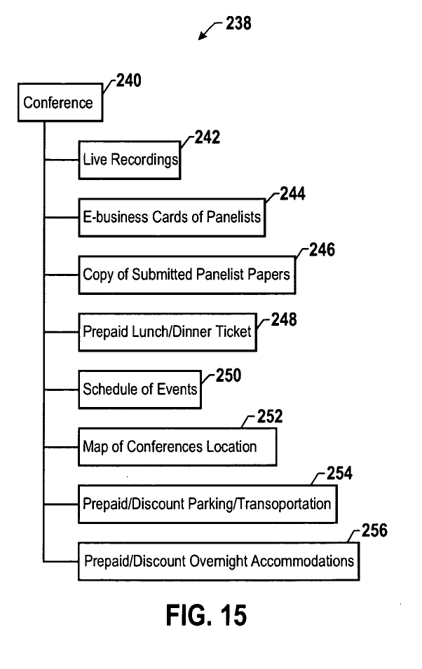

FIG. 15 may particularly address the use of allocation pointers 238 that may be associated with a conference event 240. The location pointers may include links to live recordings 242 of various sessions that may take place during the conference event that may be recorded, links to electronic business cards 244 of panelists that may speak at the conference event, and/or copies of submitted panelist papers 246. The location pointers 118 may also include links to prepaid meal tickets 248, a schedule of conference events 250, and/or a map of the conference venue 252. Furthermore, a user may be able to purchase discounted parking or transportation 254 in conjunction with the conference and/or purchase discounted overnight accommodations 256 as a result of attending the conference.

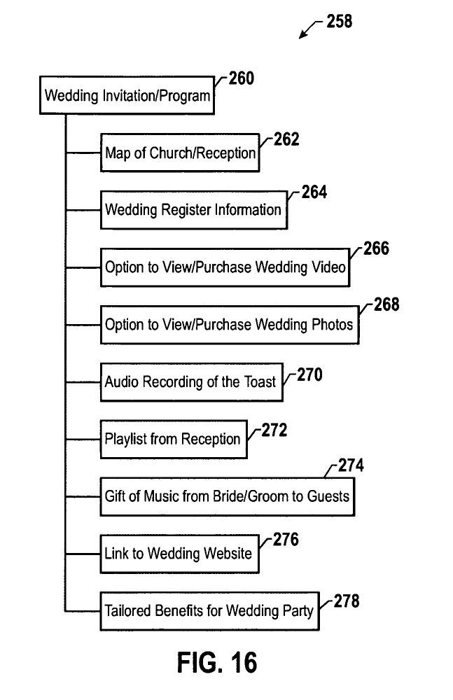

FIG. 16 illustrates a diagram 258 using base stations 76 for broadcasting location pointers 118 in conjunction with a wedding 260. The location pointers 118 may include a map of the church or reception area 262, wedding registrar information 264, an option to view or purchase the wedding video 266 and/or one or more wedding photos 268. Additionally, the location pointers 118 may display links to an audio recording of the toast 270, the playlist from the reception 272, or an opportunity to purchase a gift of music for the wedding couple 274. The location pointers 118 may further include links to the wedding website 276 and/or benefits for the wedding party 278, such as discounts on meals or accommodations.

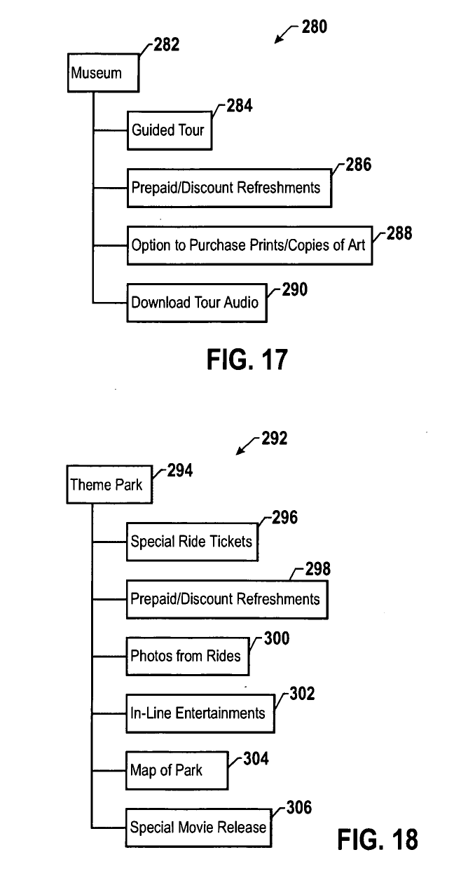

FIG. 17 illustrates a diagram 280 using base stations 76 for broadcasting location pointers 118 in conjunction with a museum 282. The location pointers 118 may include a guided tour of the museum 284, a link to prepay for or purchase discounted refreshments 286, an option to purchase copies of art showcased in the museum 288, and/or a link that allows a user to download an audio tour of the museum 290.

FIG. 18 illustrates a diagram 292 using base stations 76 for broadcasting location pointers 118 in conjunction with a theme park 294. The location pointers 118 may include special ride tickets 296, such as tickets that allow a user to avoid the lines associated with a given ride, a link to prepay for or purchase discounted refreshments 298, an option to view or purchase photographs 300 taken while on a ride or at the park 294, entertainment 302 that may be downloadable to amuse the user while in line, and/or a map of the park 304. Additionally, as some theme parks may be affiliated with movie studios, the location pointers 118 may include a link to special movie releases 306. Such special movie releases 306 may become available, for example, when a user enters the theme park and selects the corresponding location pointer 118.

Specific embodiments have been shown by way of example in the drawings and have been described in detail herein. However, it should be understood that the claims are not intended to be limited to the particular forms disclosed. Rather, the claims are to cover all modifications, equivalents, and alternatives falling within their spirit and scope.

What is claimed is:

1. An electronic device, comprising:
a base station configured to transmit on a wireless network:
one or more location pointers corresponding to one or more links to information retrievable by receiving devices of the one or more location pointers; and
location coordinates corresponding to the location of the base station.

2. The electronic device of claim 1, wherein the wireless network is a Wi-Fi network configured to operate using one or more IEEE 802.11 wireless network standards.

3. The electronic device of claim 1, wherein each of the one or more links to information comprise a specific address for an Internet location.

4. The electronic device of claim 3, wherein the base station provides a wide area network connection useable by the receiving devices of the one or more location pointers to access the specific address for the Internet location corresponding to the corresponding location pointer.

5. An electronic device comprising:
a network interface adapted to receive:
one or more location pointers corresponding to links to information transmitted from a base station; and
location coordinates corresponding to the location of the base station; and
a display adapted to display the location pointers and a representation of a map corresponding to the current location of the electronic device.

6. The electronic device of claim 5, wherein the electronic device is adapted to navigate to one or more Internet addresses corresponding to the one or more location pointers.

7. The electronic device of claim 6, wherein navigation to the one or more Internet addresses is accomplished using a wide area network connection transmitted from the base station.

8. The electronic device of claim 6, wherein navigation to the Internet address is accomplished using a wide area network connection internal to the electronic device.

9. The electronic device of claim 8, wherein the wide area network connection internal to the electronic device corresponds to an EDGE connection or a 3G connection.

10. The electronic device of claim 5, wherein the electronic device is adapted to utilize the location coordinates corresponding to the location of the base station to determine the location of the electronic device.

11. The electronic device of claim 10, wherein the display is adapted to display a pin location corresponding to the determined location of the electronic device on the representation of the map.

12. A computer program stored on a tangible computer readable medium, the computer program comprising instructions operable to cause a processor to:
provide a setup page adapted to list one or more display names and destinations corresponding to one or more location pointers, wherein the one or more location pointers correspond to one or more links to information;
provide editing capability for editing the one or more display names and destinations; and
provide an add function for adding at least one location pointer to the setup page.

13. The computer program of claim 12, wherein the instructions cause the processor to transmit the one or more location pointers from a server to various base stations communicatively coupled to the server.

14. The computer program of claim 12, wherein the one or more links to information correspond to one or more Internet addresses.

15. The computer program of claim 12, wherein editing the one or more display names alters the name of the one or more location pointers transmitted from a base station.

16. The computer program of claim 12, wherein editing the one or more destinations alters the one or more links to information of the one or more location pointers.

17. A method for wireless communication, comprising:
transmitting one or more location pointers corresponding to one or more links to information from a base station; and
transmitting from the base station location coordinates corresponding to the location of the base station.

18. The method of claim 17, wherein the one or more links to information comprise specific addresses for one or more Internet locations.

19. The method of claim 17, comprising providing a network connection useable to access an address for the one or more Internet locations corresponding to the one or more location pointers.

20. A method for wireless communication, comprising:
receiving in a device one or more location pointers corresponding to one or more links to information and location coordinates corresponding to the location of a known point.

21. The method of claim 20, wherein the one or more links to information comprise specific addresses for one or more Internet locations.

22. The method of claim 20, comprising determining if a transmitter of the location pointers provides a network connection useable by the device to access addresses for one or more Internet locations corresponding to the one or more location pointers, and utilizing the wide area network connection if provided to access the addresses for the one or more Internet locations corresponding to the one or more location pointers.

23. The method of claim 22, comprising utilizing using an internal network connection internal to the electronic device if the transmitter of the location pointers does not provide a network connection useable by the device to access the addresses of the one or more Internet locations corresponding to the one or more specified location pointers.

24. The method of claim 20, comprising utilizing the location coordinates corresponding to the location of the known point to determine the location of the electronic device.

25. The method of claim 24, comprising displaying a pin location corresponding to the determined location of the electronic device on a representation of a map generated in the device.

26. An electronic device, comprising:
a base station configured to transmit one or more location pointers on a wireless network, wherein the one or more location pointers correspond to one or more links to information retrievable by receiving devices of the one or more location pointers.

27. The electronic device of claim 26, wherein the wireless network is a Wi-Fi network configured to operate using one or more IEEE 802.11 wireless network standards.

28. The electronic device of claim 26, wherein each of the one or more links to information comprise a specific address for an Internet location.

29. The electronic device of claim 26, wherein the base station provides a wide area network connection useable by the receiving devices of the one or more location pointers to access the specific address for the Internet location corresponding to the corresponding location pointer.

30. An electronic device, comprising:
a base station configured to transmit location coordinates corresponding to the location of the base station.

31. The electronic device of claim 1, wherein the location coordinates corresponding to the location of the base station are transmitted wirelessly.

32. The method of claim 31, wherein the location coordinates corresponding to the location of the base station are adapted to convey a distance between a receiver of the location coordinates and the base station.
